(19) United States
(12) Patent Application Publication
(10) Pub. No.: US 2026/0121402 A1
(43) Pub. Date: Apr. 30, 2026

(54) ESD PROTECTION CIRCUIT

(71) Applicant: STMicroelectronics International N.V., Geneva (CH)

(72) Inventor: Philippe GALY, Le Touvet (FR)

(73) Assignee: STMicroelectronics International N.V., Geneva (CH)

(21) Appl. No.: 19/368,272

(22) Filed: Oct. 24, 2025

(30) Foreign Application Priority Data
Oct. 28, 2024 (FR) FR2411780

(51) Int. Cl. H02H 9/04; H02H 9/02

(52) U.S. Cl. CPC H02H 9/046; H02H 9/025; H02H 9/048

(57) ABSTRACT

An electrostatic discharge protection circuit incudes an electrostatic discharge dissipation component having a first conduction terminal, a second conduction terminal, and a control terminal. Identical first and second devices each include first and second conduction terminals, where the respective first conduction terminals of the first and second devices are connected to the control terminal of the electrostatic discharge dissipation component, and the respective second terminals of the first and second devices are respectively connected to the first conduction terminal of the electrostatic discharge dissipation component and to the second conduction terminal of the electrostatic discharge dissipation component.

### PRIORITY CLAIM

This application claims the priority benefit of French Application for Patent No. FR2411780, filed on Oct. 28, 2024, the content of which is hereby incorporated by reference in its entirety to the maximum extent allowable by law.

### TECHNICAL FIELD

The present disclosure generally concerns integrated electronic circuits, and more particularly electrostatic discharge protection circuits (ESD).

### BACKGROUND

FIG. 1 shows an example of a component Cesd used as an ESD protection circuit.

Component Cesd comprises a BiMOS transistor 100, a first conduction terminal A1, a second conduction terminal A2, and a terminal C for controlling a conduction state of component Cesd1 between its terminals A1 and A2.

A BiMOS transistor is a MOS transistor having its front gate electrode, also called gate or control terminal of the MOS transistor in the rest of the present disclosure, which is connected to its channel-forming region. The channel-forming region of the MOS transistor, also called channel region (or body region) of the MOS transistor in the rest of the present disclosure, corresponds to the region of the MOS transistor which extends between the source and the drain of the MOS transistor, and where the channel of the MOS transistor forms.

The gate of BiMOS transistor 100 is connected to the control terminal C of component Cesd. First and second conduction terminals of BiMOS transistor 100, corresponding to the source and to the drain of BiMOS transistor 100, are connected to the respective terminals A1 and A2. As an example, BiMOS transistor 100 has an N channel.

Component Cesd is commonly used to dissipate an ESD occurring on either of its terminals A1 and A2. In other words, component Cesd is an ESD dissipation component. Still in other words, component Cesd turns on when it receives an ESD higher than a threshold on one or the other of its terminals A1 and A2, this turn on resulting in the implementation, by component Cesd, of a conductive electrical path between its terminals A1 and A2, so that the ESD is discharged towards the other of terminals A2 and A1.

However, component Cesd has disadvantages.

There exists a need for an ESD protection circuit which overcomes all or part of the disadvantages of an ESD protection component of the type of that described in relation with FIG. 1.

There is a need, for example, to have an ESD protection circuit having a symmetrical response for ESDs occurring on its terminal A1 and for ESDs occurring on its terminal A2.

It would be desirable, for example, to have an ESD protection circuit comprising no BiMOS transistor but implementing a BiMOS transistor between its terminals A1, A2, and C. In other words, it would be desirable to have an ESD protection circuit comprising no BiMOS transistor but being functionally identical to a BiMOS transistor between its terminals A1, A2, and C, that is, the protection circuit emulates the operation of a BiMOS transistor between its terminals A1, A2, and C. Indeed, in certain technologies such as SOI (Silicon On Insulator), FD-SOI (Fully Depleted SOI), and hybrid bulk technologies, there is not always an electrical contact to the channel region of a transistor, which makes it impossible to implement a BiMOS transistor.

It would be desirable, for example, to have an ESD protection circuit which can receive a disable signal. Indeed, ESD here designates an electrical discharge occurring on one or the other of the terminals A1 and A2 of the protection circuit while the electronic circuit comprising the protection circuit is not powered. Providing to disable the protection circuit when the electronic circuit comprising the protection circuit is powered enables for an electrical overstress (EOS) occurring on one of the terminals A1 and A2 of the protection circuit not to cause turn on of the protection circuit.

It would be desirable, for example, to have an ESD protection circuit which has a turn-on threshold different from that of component Cesd, for example a threshold lower than that of component Cesd, but, preferably, without for this to increase current leakage between terminals A1 and A2 when the electronic circuit which comprises the protection circuit is powered.

There is a need to overcome all or part of the disadvantages of ESD protection components of the type of that described in relation with FIG. 1.

### SUMMARY

An embodiment provides an electrostatic discharge protection circuit comprising: an electrostatic discharge dissipation component comprising a first conduction terminal, a second conduction terminal, and a terminal for controlling a conduction state of the electrostatic discharge dissipation component between its first and second terminals, the electrostatic discharge dissipation component being one of: a MOS transistor, a BiMOS transistor, and a circuit functionally equivalent to a BiMOS transistor; and identical first and second devices, each comprising first and second conduction terminals, the respective first terminals of the first and second devices being connected to the control terminal of the electrostatic discharge dissipation component, the respective second terminals of the first and second devices being respectively connected to the first terminal of the electrostatic discharge dissipation component and to the second terminal of the electrostatic discharge dissipation component.

According to an embodiment, each of the first and second devices comprises at least one PN junction.

According to an embodiment, each of the first and second devices is implemented by one of: a MOS transistor, a BiMOS transistor, and a circuit functionally equivalent to a BiMOS transistor.

According to an embodiment: each of the first and second devices further comprises a terminal for controlling a conduction state of the device between its first and second terminals; each of the first and second devices is implemented by one of: a MOS transistor, a BiMOS transistor, and a circuit functionally equivalent to a BiMOS transistor; wherein the protection circuit further comprises: a first MOS transistor having a first conduction terminal connected to the first component terminal, a second conduction terminal connected to the control terminal of the second device, and a gate configured to receive a signal for disabling the protection circuit; and a second MOS transistor having a first conduction terminal connected to the control terminal of the first device, a second conduction terminal connected to the second terminal of the component, and a gate configured to receive the signal for disabling the protection circuit.

According to an embodiment: the protection circuit further comprises: a third device comprising a first conduction terminal connected to the first terminal of the component, a second conduction terminal connected to the control terminal of the component, and a control terminal; a fourth device identical to the third device, the first terminal of the fourth device being connected to the second terminal of the component, and the second terminal of the fourth device being connected to the second terminal of the third device; wherein each of the third and fourth devices is implemented by one of: a MOS transistor, a BiMOS transistor, and a circuit functionally equivalent to a BiMOS transistor; and first and second MOS transistors; the first MOS transistor having a first conduction terminal connected to the first terminal of the component, a second conduction terminal connected to the control terminal of the fourth device, and a gate configured to receive a disable signal from the protection circuit; and the second MOS transistor having a second conduction terminal connected to the second terminal of the component, a first conduction terminal connected to the terminal for controlling the third device, and a gate configured to receive the signal for disabling the protection circuit.

According to an embodiment: the component is a MOS transistor; and the first and second devices comprise no BiMOS transistor and are configured so that the protection circuit is functionally equivalent to a BiMOS transistor; the first and second terminals of the component are functionally equivalent respectively to first and second conduction terminals of said BiMOS transistor, and the control terminal of the component is functionally equivalent to a gate of said BiMOS transistor.

According to an embodiment, each of the first and second devices comprises: a diode with a control gate having a first electrode connected to the first terminal of said device, a second electrode connected to the second terminal of said device, and its gate connected to its second electrode.

According to an embodiment, each of the first and second devices comprises: a MOS transistor having one conduction terminal connected to the first terminal of said device, another conduction terminal connected to the second terminal of said device, and a gate connected to the first terminal of said device.

According to an embodiment, each of the first and second devices comprises: a first MOS transistor having a gate, a first conduction terminal connected to the first terminal of said device, a second conduction terminal connected to the second terminal of said device; and a second MOS transistor having a first conduction terminal connected to the second terminal of said device, a second conduction terminal connected to the gate of the first transistor, and a gate connected to the second terminal of said device.

According to an embodiment, each of the first and second devices comprises: a first MOS transistor having a gate, a first conduction terminal connected to the first terminal of said device, a second conduction terminal connected to the second terminal of said device; and a second MOS transistor having a first conduction terminal connected to the second terminal of said device, a second conduction terminal connected to the gate of the first transistor, and a gate connected to the first terminal of said device.

According to an embodiment, the gate of the first transistor of the second device is configured to receive a signal for disabling the circuit.

According to an embodiment, each of the first and second devices comprises: a MOS transistor having a conduction terminal connected to the first terminal of said device, another conduction terminal connected to the second terminal of said device, and a gate connected to the second terminal of said device.

Another embodiment provides an electrostatic discharge protection device comprising: first and second electrostatic discharge protection circuits such as defined hereabove, the control terminal of the component of the first circuit being connected to the control terminal of the component of the second circuit; a first MOS transistor having its gate connected to the control terminals of the components of the first and second circuits, a first conduction terminal connected to the first terminal of the component of the first circuit, and a second conduction terminal connected to the first terminal of the component of the second circuit; and a second MOS transistor having its gate connected to the control terminals of the components of the first and second circuits, a first conduction terminal connected to the second terminal of the component of the first circuit, and a second conduction terminal connected to the second terminal of the component of the second circuit.

According to an embodiment, the gate of the first transistor is configured to receive a signal for disabling the device.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1, previously described, shows a BiMOS transistor used as an ESD protection circuit;

FIG. 2 shows an example of an embodiment of an ESD protection circuit;

FIG. 3 shows an example of an embodiment of an ESD protection circuit comprising the circuit of FIG. 2;

FIG. 4 shows an example of another embodiment of an ESD protection circuit comprising the circuit of FIG. 2;

FIG. 5 shows an example of an embodiment of an ESD protection circuit functionally equivalent to a BiMOS transistor;

FIG. 6 illustrates an example of implementation of the circuit of FIG. 5;

FIG. 7 shows another example of an embodiment of an ESD protection circuit functionally equivalent to a BiMOS transistor;

FIG. 8 illustrates an example of implementation of the circuit of FIG. 7;

FIG. 9 shows still another example of an embodiment of an ESD protection circuit functionally equivalent to a BiMOS transistor;

FIG. 10 illustrates an example of implementation of the circuit of FIG. 9;

FIG. 11 shows still another example of an embodiment of an ESD protection circuit functionally equivalent to a BiMOS transistor;

FIG. 12 shows still another example of an embodiment of an ESD protection circuit functionally equivalent to a BiMOS transistor; and

FIG. 13 shows another embodiment of an ESD protection circuit or device.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10% or 10°, preferably of plus or minus 5% or 5°.

Unless otherwise specified, when reference is made to the gate of a transistor (MOS or BiMOS), this designates the front gate electrode of the transistor.

Unless otherwise specified, when reference is made to a MOS transistor, this designates a MOS transistor, the gate of which is not connected to the channel region of the transistor, or, in other words, this designates a MOS transistor which is not a BiMOS transistor.

Unless otherwise specified, when reference is made to a BiMOS transistor, this designates a MOS transistor having its gate connected to the channel region of the transistor.

FIG. 2 shows an example of an embodiment of an ESD protection circuit, Cesd2.

Circuit Cesd2 comprises a component Cesd1. Component Cesd1 comprises a conduction terminal A1, a conduction terminal A2, and a control terminal C for controlling the conduction state, for example on or off, of component Cesd1 between its terminals A1 and A2. Component Cesd1 is an ESD dissipation component, that is, component Cesd1 turns on when it receives an ESD higher than a threshold on one or the other of its terminals A1 and A2, this turn on resulting in the implementation, by component Cesd1, of a conductive electrical path between its terminals A1 and A2, so that the ESD is discharged to the other of terminals A2 and A1.

The terminal A1 of component Cesd1 corresponds to a terminal A1 of circuit Cesd2, both terminals thus being designated with the same reference A1. For example, the terminal A1 of component Cesd1 forms the terminal A1 of circuit Cesd2. The terminal A2 of component Cesd1 corresponds to the terminal A2 of circuit Cesd2, these two terminals being designated by the same reference A2. For example, the terminal A2 of component Cesd1 constitutes the terminal A2 of circuit Cesd2.

As an example, circuit Cesd2 comprises a control terminal C. The control terminal C of circuit Cesd2 controls the conduction state of circuit Cesd2 between its terminals A1 and A2. The terminal C of component Cesd1 then corresponds to the terminal C of circuit Cesd2, these two terminals thus being designated by the same reference C. For example, the terminal C of component Cesd1 is the terminal C of circuit Cesd2.

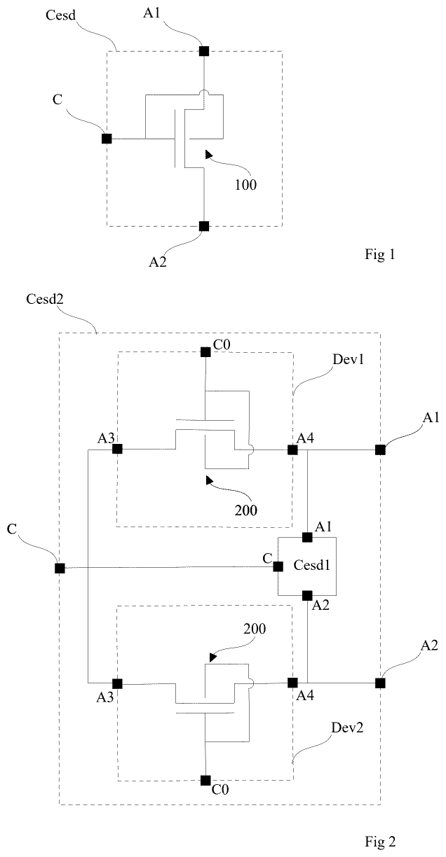

According to an embodiment, component Cesd1 is identical to the component Cesd of FIG. 1.

Circuit Cesd2 further comprises two identical devices Dev1 and Dev2. Each of the two devices Dev1 and Dev2 comprises a conduction terminal A3 and a conduction terminal A4.

In the embodiment shown in FIG. 2, each of devices Dev1 and Dev2 further comprises a control terminal C0 controlling the conduction state of the device between its terminals A3 and A4.

In the embodiment of FIG. 2, the control terminal C0 of each of devices Dev1 and Dev2 is floating.

In alternative embodiments, this control terminal C0 is omitted.

According to an embodiment, each of devices Dev1 and Dev2 comprises a PN junction.

For example, in the embodiment shown in FIG. 2, each of devices Dev1 and Dev2 comprises a BiMOS transistor 200. For example, in each of devices Dev1 and Dev2, one conduction terminal of BiMOS transistor 200 is connected to the terminal A4 of the device, and another conduction terminal of BiMOS transistor 200 is connected to the terminal A3 of the device. The gate of BiMOS transistor 200 forms the control terminal C0 of the device when it is present. The gate of BiMOS transistor 200 is here left floating.

The terminal A3 of device Dev1, respectively of device Dev2, is connected to the terminal C of component Cesd1. The terminal A4 of device Dev1 is connected to the terminal A1 of component Cesd1. The terminal A4 of device Dev2 is connected to the terminal A2 of component Cesd1.

In other words, devices Dev1 and Dev2 are symmetrically connected between the terminals A1 and C of component Cesd1 and between the terminals A2 and C of component Cesd1. Still in other words, the connection of device Dev1 between the terminals A1 and C of component Cesd1 is identical to that of device Dev2 between the terminals A2 and C of component Cesd1.

An advantage of the embodiment of FIG. 2, in the case where each of devices Dev1 and Dev2 is a BiMOS transistor 200, is that the triggering of component Cesd1, and thus of circuit Cesd2, during an ESD on one or the other of its terminals A1 and A2, is faster than for component Cesd.

Another advantage of the embodiment of FIG. 2 is that the response of circuit Cesd2 to an ESD on its terminal A1 is symmetrical to the response of circuit Cesd2 to an ESD on its terminal A2.

As a variant, rather than being a BiMOS transistor, component Cesd1 may be a MOS transistor. For example, when component Cesd1 is a MOS transistor, for example with an N channel, the gate of the MOS transistor is connected to the control terminal C of component Cesd1, and the first and second conduction terminals of the MOS transistor, corresponding to the source and drain of the transistor, are connected to respective terminals A1 and A2.

As another variant, rather than being a BiMOS or MOS transistor, component Cesd1 may be a circuit comprising no BiMOS transistor but functionally identical to a BiMOS transistor. Component Cesd1 then emulates the operation of a BiMOS transistor, with its gate connected to control terminal C and its first and second conduction terminals connected to the respective terminals A1 and A2.

As further variants, combinable with the variants relative to the implementation of component Cesd1, identical devices Dev1 and Dev2 symmetrically connected to component Cesd1 may be implemented otherwise than with BiMOS transistors 200.

For example, each device Dev1, Dev2 may be a MOS transistor, for example with an N channel, having its first and second conduction terminals, corresponding to the source and to the drain of the transistor, connected to the respective terminals A3 and A4, and its gate connected to the control terminal C0 of component Cesd1 when it is present. As another example, each device Dev1, Dev2 may be a circuit comprising no BiMOS transistor but functionally identical to a BiMOS transistor, the device then emulates the operation of a BiMOS transistor having its first and second conduction terminals connected to the respective terminals A3 and A4 and its gate connected to control terminal C0 when it is present.

In the case where each device Dev1, Dev2 is a BiMOS transistor, a circuit emulating the operation of a BiMOS transistor, or a MOS transistor, during an ESD, circuit Cesd2 turns on faster than in the case where these devices are absent.

In the case where each device Dev1, Dev2 is a BiMOS transistor or a circuit emulating the operation of a BiMOS transistor, the turn-on threshold of circuit Cesd2 during an ESD will be lower than when each device Dev1, Dev2 is a MOS transistor.

Further, in the embodiments and variants described hereabove in relation with FIG. 2, the provision of two identical devices Dev1 and Dev2 symmetrically connected to component Cesd1 enables the response of circuit Cesd2 to an ESD on its terminal A1 to be symmetrical to its response to an ESD on its terminal A2.

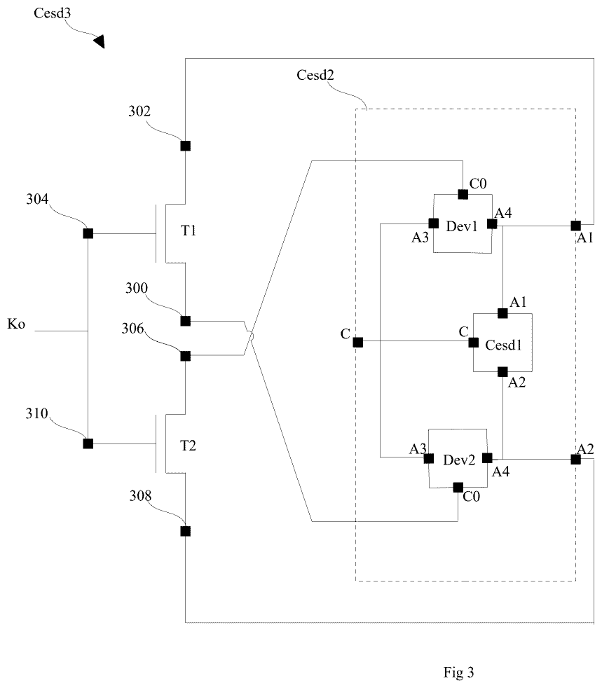

FIG. 3 shows an example of an embodiment of an ESD protection circuit, Cesd3, comprising the circuit Cesd2 described hereabove. The terminals A1 and A2 of circuit Cesd2, and thus of component Cesd1, form two terminals A1 and A2 of circuit Cesd3.

In the embodiment of FIG. 3, devices Dev1 and Dev2 each comprise control terminal C0.

Circuit Cesd3 further comprises a MOS transistor T1 and a MOS transistor T2, for example identical. Transistors T1 and T2 for example have an N channel.

Transistor T1 has a conduction terminal 300 connected to the control terminal C0 of device Dev2, another conduction terminal 302 connected to the terminal A1 of component Cesd1, hence of circuit Cesd2, and its gate 304 is configured to receive a signal Ko for disabling circuit Cesd3. Symmetrically, transistor T2 has a conduction terminal 306 connected to the control terminal C0 of device Dev1, another conduction terminal 308 connected to the terminal A2 of component Cesd1, hence of circuit Cesd2, and its gate 310 is configured to receive signal Ko. Thus, in the embodiment of FIG. 3, the control terminal C of the component Cesd1 is coupled to the signal Ko. More particularly, the control terminal C of the component Cesd1 is coupled to the signal Ko via the devices Dev1 and Dev2, and the transistors T1 and T2.

When the electronic circuit comprising circuit Cesd3 is not powered, signal Ko is floating (or inactive). Transistors T1 and T2 are thus off, and the operation of circuit Cesd2 is then the same as that described in relation with FIG. 2. Circuit Cesd3 is then active, and enables to discharge an ESD occurring on one or the other of its terminals A1 and A2.

On the other hand, when the electronic circuit comprising circuit Cesd3 is powered, this electronic circuit is configured to supply signal Ko at a level enabling to turn on transistors T1 and T2, that is, signal Ko is active. For example, signal Ko corresponds to a non-zero and positive voltage. This enables to ensure that component Cesd1 remains in the off state between its terminals A1 and A2, even in the presence of an overstress on one or the other of its terminals A1 and A2. Circuit Cesd3 is then disabled and does not turn on.

For example, when circuit Cesd3 is disabled and an overstress occurs on terminal A1, that is, the potential of terminal A1 increases with respect to that of terminal A2 (positive overstress), due to the fact that transistors T1 and T2 are on, device Dev2 is controlled to the on state. The terminal C of component Cesd1 is then pulled to the potential of terminal A2, and component Cesd1 thus remains in the off state. Conversely, when circuit Cesd3 is disabled and an overstress occurs on terminal A2, that is, the potential of terminal A2 decreases with respect to that of terminal A1 (negative overstress), due to the fact that transistors T1 and T2 are on, device Dev1 is controlled to the on state. The terminal C of component Cesd1 is then pulled to the potential of terminal A1, and component Cesd1 thus remains in the off state.

Circuit Cesd3, in addition to benefiting from the advantages of circuit Cesd2 with regard to the discharge of an ESD on one or the other of terminals A1 and A2 when circuit Cesd3 is active, can thus be disabled by signal Ko, so that circuit Cesd3 does not turn on in the presence of an overstress on one or the other of terminals A1 and A2.

Preferably, when the electronic circuit comprising circuit Cesd3 is powered and the voltage between terminals A1 and A2, referenced to terminal A2, is higher than the turn-on threshold of a PN diode, that is, higher than 0.6 V, devices Dev1 and Dev2 are preferably implemented with a MOS transistor rather than with a BiMOS transistor or a circuit equivalent to a BiMOS transistor. Indeed, this enables to decrease leakage currents through transistor T1 and device Dev2, with respect to the case where devices Dev1 and Dev2 each are a BiMOS transistor or a circuit equivalent to a BiMOS transistor. In the case where the voltage between terminals A1 and A2 is lower than the turn-on threshold of a PN diode, devices Dev1 and Dev2 may each be a MOS transistor, a BiMOS transistor, or a circuit equivalent to a BiMOS transistor, without for this to have any impact on leakage currents.

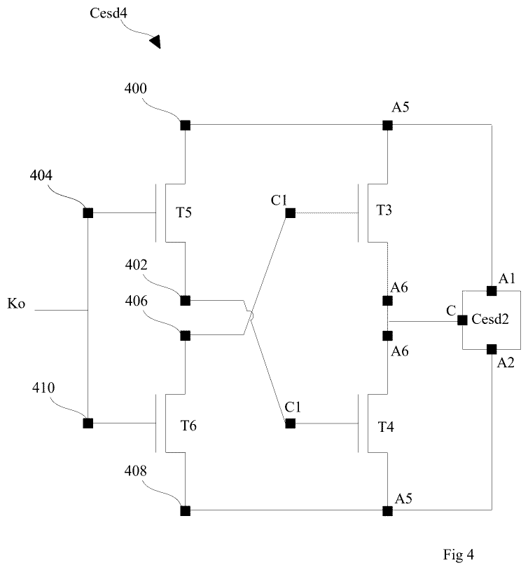

FIG. 4 shows an example of another ESD protection circuit Cesd4 comprising the previously-described circuit Cesd2. The terminals A1 and A2 of circuit Cesd2, and thus of component Cesd1, form two terminals A1 and A2 of circuit Cesd4.

Circuit Cesd4 comprises four MOS transistors T3, T4, T5, and T6, for example, with an N channel.

Transistor, or device, T3 has a conduction terminal A5 connected to the terminal A1 of circuit Cesd2, another conduction terminal A6 connected to the control terminal of circuit Cesd2 and a control terminal (or gate) C1.

Transistor, or device, T4 is identical to transistor T3. Transistor T4 has its conduction terminal A5 connected to the terminal A2 of circuit Cesd2, and its conduction terminal A6 connected to the terminal C of component Cesd2.

Devices T3 and T4 are thus connected to circuit Cesd2 symmetrically to each other.

Transistor T5 has a conduction terminal 400 connected to the terminal A1 of circuit Cesd2, another conduction terminal 402 connected to the control terminal C1 of device T4, and its gate 404 is configured to receive a signal Ko for disabling circuit Cesd4. Symmetrically, transistor T6 has one conduction terminal 406 connected to the control terminal C1 of device T3, another conduction terminal 408 connected to the terminal A2 of circuit Cesd2, and its gate 410 is configured to receive signal Ko. Thus, in the embodiment of FIG. 4, the control terminal C of the component Cesd2 is coupled to the signal Ko. More particularly, the control terminal C of the component Cesd2 is coupled to the signal Ko via the transistors T3, T4, T5 and T6.

When the electronic circuit comprising circuit Cesd4 is not powered, signal Ko is floating (or inactive). Transistors T3, T4, T5, and T6 are off, and the operation of circuit Cesd2 is then the same as described in relation with FIG. 2. Circuit Cesd4 is then active, and enables to discharge an ESD occurring on one or other of its terminals A1 and A2.

On the other hand, when the electronic circuit comprising circuit Cesd4 is powered, this electronic circuit is configured to supply signal Ko at a level enabling to turn on transistors T5 and T6, that is, signal Ko is active. For example, signal Ko then corresponds to a non-zero and positive voltage. This enables to ensure that circuit Cesd2, and thus circuit Cesd4, remains in the off state between its terminals A1 and A2, even in the presence of an overstress on one or the other of its terminals A1 and A2. Circuit Cesd4 is then disabled and does not turn on.

For example, when circuit Cesd4 is disabled and an overstress occurs on terminal A1, that is, the potential of terminal A1 increases with respect to that of terminal A2 (positive overstress), due to the fact that transistors T5 and T6 are on, device T4 is controlled to the on state. The terminal C of circuit Cesd2 is then pulled to the potential of terminal A2 and circuit Cesd2 thus remains in the off state. Conversely, when circuit Cesd4 is disabled and an overstress occurs on terminal A2, that is, the potential of terminal A2 decreases with respect to that of terminal A1 (negative overstress), due to the fact that transistors T5 and T6 are on, device T3 is controlled to the on state. The terminal C of circuit Cesd2 is then pulled to the potential of terminal A1, and component Cesd1 remains in the off state.

Circuit Cesd4, in addition to benefiting from the advantages of circuit Cesd2 as concerns the discharge of an ESD on one or the other of terminals A1 and A2 when circuit Cesd4 is active, can thus be disabled by signal Ko, so that circuit Cesd4 does not turn on in the presence of an overstress on one or the other of terminals A1 and A2.

In the embodiment of FIG. 4, each device T3 and T4 is a MOS transistor. In alternative embodiments, each device T3, T4 is replaced with a BiMOS transistor having conduction terminals A5 and A6 and a control terminal C1, or with a circuit equivalent to a BiMOS transistor, this circuit comprising two conduction terminals A5 and A6 and a control terminal.

Preferably, when the electronic circuit comprising circuit Cesd4 is powered and the voltage between terminals A1 and A2, referenced to terminal A2, is higher than the turn-on threshold of a PN diode, devices T3 and T4 are preferably MOS transistors rather than BiMOS transistors or circuits each equivalent to a BiMOS transistor. Indeed, this enables to decrease leakage currents through transistor T5 and device T4, with respect to the case where devices T3 and T4 each are BiMOS transistors or circuits equivalent to BiMOS transistors. In the case where the voltage between terminals A1 and A2 is lower than the turn-on threshold of a PN diode, devices T3 and T4 may each be a MOS transistor, a BiMOS transistor, or a circuit equivalent to a BiMOS transistor without for this to have an impact on leakage currents.

Circuits equivalent to BiMOS transistors but implemented without BiMOS transistors have been mentioned several times hereabove. Examples of embodiment of such circuits will now be described.

FIG. 5 shows an example of an embodiment of a circuit Cesd5 functionally equivalent to a BiMOS transistor, circuit Cesd5 being an ESD protection circuit.

Circuit Cesd5 comprises two conduction terminals A1′ and A2′ and a control terminal C′, corresponding to the respective terminals A1, A2, and C of the BiMOS transistor 100 shown in FIG. 1.

Circuit Cesd5 comprises an ESD dissipation component, Cesd1′. More particularly, component Cesd1′ is a MOS transistor, for example with an N channel. MOS transistor Cesd1′ comprises a conduction terminal corresponding to the terminal A1′ of circuit Cesd1′, these two terminals thus being designated by the same reference A1′. MOS transistor Cesd1′ has another conduction terminal corresponding to the terminal A2′ of circuit Cesd1′, these two terminals being designated by the same reference A2′. MOS transistor Cesd1′ comprises a gate corresponding to the terminal C′ of circuit Cesd1′, these two terminals being designated by the same reference C′.

Circuit Cesd5 further comprises two identical devices Dev1′ and Dev2′. Each of the two devices Dev1′ and Dev2′ comprises a conduction terminal A3′ and a conduction terminal A4′.

According to an embodiment, each of devices Dev1′ and Dev2′ comprises a PN junction.

In the embodiment shown in FIG. 5, each of devices Dev1′ and Dev2′ comprises a gated diode 500. For example, in each of devices Dev1′ and Dev2′, a first electrode, for example, the anode, of diode 500 is connected to the terminal A3′ of the device and a second electrode, for example, the cathode, of diode 500 is connected to the terminal A4′ of the device, and the gate of diode 500 is connected to its second electrode.

The terminal A3′ of device Dev1′, respectively of device Dev2′, is connected to the terminal C′ of component Cesd1′. The terminal A4′ of device Dev1′ is connected to the terminal A1′ of component Cesd1′. The terminal A4′ of device Dev2′ is connected to the terminal A2′ of component Cesd1′.

In other words, devices Dev1′ and Dev2′ are symmetrically connected between the terminals A1′ and C′ of component Cesd1′ and between the terminals A2′ and C′ of component Cesd1. In other words, the connection of device Dev1′ between the terminals A1′ and C′ of component Cesd1′ is identical to that of device Dev2′ between the terminals A2′ and C′ of component Cesd1′.

An advantage of circuit Cesd5 is that it is equivalent to a BiMOS transistor, but that it comprises no BiMOS device. Thus, circuit Cesd5 can be implemented with components (MOS transistor and gated diode) which do not require a contact with a channel region of a transistor.

In particular, in the embodiments and variants previously described in relation with FIGS. 2 to 4, component Cesd1 may be implemented with the circuit Cesd5 of FIG. 5, the terminals A1′, A2′, and C′ of circuit Cesd5 then corresponding to the respective terminals A1, A2, and C of component Cesd1.

Further, in the embodiments and variants previously described in relation with FIGS. 2 to 4, each of devices Dev1 and Dev2 may be implemented by a circuit Cesd5, with the terminals A3, A4, and C0 of the device corresponding to the respective terminals A1′, A2′, and C′ of circuit Cesd5.

Further, in the embodiments and variants described in relation with FIG. 4, each of devices T3 and T4 may be implemented by a circuit Cesd5, the terminals A5, A6, and C1 of the device corresponding to the respective terminals A1′, A2′, and C′ of circuit Cesd5.

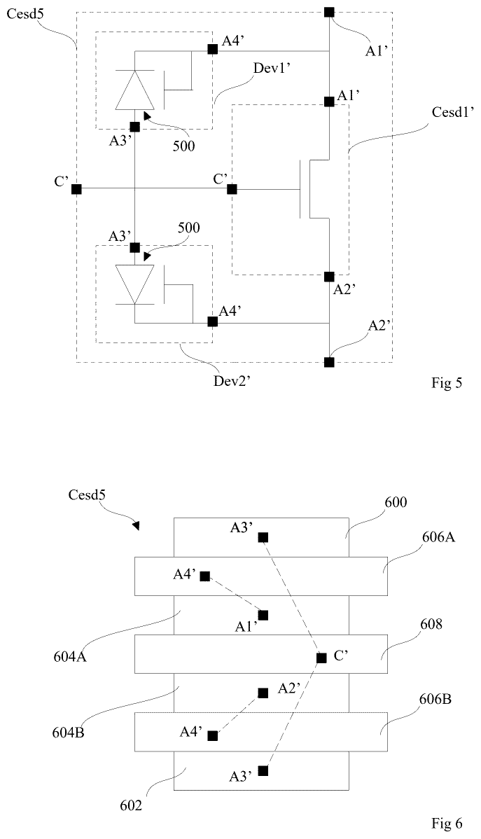

Further, as shown in FIG. 6, the hardware implementation of circuit Cesd5 may be very compact.

FIG. 6 shows, in a simplified top view, an example of compact implementation of the circuit Cesd5 of FIG. 5.

Circuit Cesd5 successively comprises, in contact two by two, a doped region 600 of a first conductivity type, for example type P, a doped region of the first conductivity type (not shown in FIG. 6) arranged under a gate 606A, a doped region 604A of a second conductivity type, for example type N, a doped region of the first conductivity type (not shown in FIG. 6) arranged under a gate 608, a doped region 604B of the second conductivity type, a doped region of the first conductivity type (not shown in FIG. 6) arranged under a gate 606B, and a doped region 602 of the first conductivity type. The region of the first conductivity type arranged under gate 606A and the doped region 604A of the second conductivity type form the PN junction of the diode 500 of one of devices Dev1′ and Dev2′, gate 606A forming the gate of this diode 500. The region of the first conductivity type arranged under gate 606B and the doped region 604A of the second conductivity type form the PN junction of diode 500, gate 606B forming the gate of this diode 500. The doped region of the first conductivity type under gate 608 forms the channel region of transistor Cesd1′, gate 608 corresponding to the gate of this transistor. As an example, the doped regions of the first conductivity type arranged under gates 606A, 606B, and 608 have a doping level lower than that of the doped regions 600 and 602 of the first conductivity type.

In FIG. 6, the terminals A3′ and A4′ of devices Dev1′ and Dev2′ have been shown as solid squares, and the terminals A1′, A2′, and C′ of transistor Cesd1′ have been shown as solid squares, and the connections between these terminals have been shown with dotted lines.

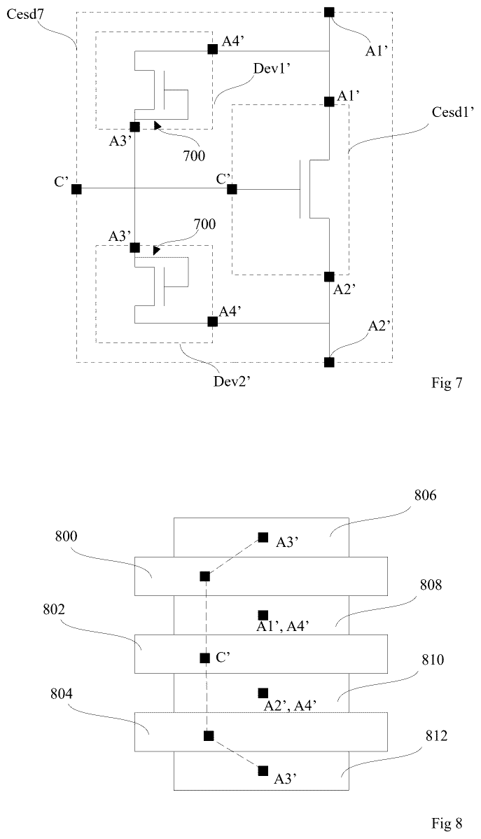

FIG. 7 shows another example of a circuit Cesd7 equivalent to a BiMOS transistor, circuit Cesd7 being an ESD protection circuit.

Circuit Cesd7 comprises many elements in common with circuit Cesd5, and only the differences between the two are detailed here. Thus, unless otherwise indicated, all that has been indicated for circuit Cesd5, in particular its advantages and uses, applies to circuit Cesd7.

More particularly, circuit Cesd7 differs from circuit Cesd5 only by the implementation of its devices Dev1′ and Dev2′.

In each device Dev1′, Dev2′ of circuit Cesd7, diode 500 is replaced by a MOS transistor 700, for example having an N channel, with a gate connected to a conduction terminal. For example, in each of devices Dev1′ and Dev2′, a first conduction terminal of transistor 700 is connected to the terminal A3′ of the device, a second conduction terminal of transistor 700 is connected to the terminal A4′ of the device, and the gate of transistor 700 is connected to its first conduction terminal.

FIG. 8 shows, in a simplified top view, an example of compact implementation of the circuit Cesd7 of FIG. 7.

Circuit Cesd7 comprises three gates 800, 802, and 804 corresponding to the respective gates of the transistor 700 of device Dev1′, of transistor Cesd1′, and of the transistor 700 of device Dev2′, gate 802 being arranged between gates 800 and 804. Each of gates 800, 802, and 804 is arranged on a corresponding doped channel region of a first conductivity type, for example P. The channel region arranged under gate 800 is bordered on either side by two respective doped regions 806 and 808 of a second conductivity type, for example N, and respectively corresponding to the terminals A3′ and A4′ of device Dev1′. Region 808 also borders the channel region arranged under gate 802 and thus also corresponds to the conduction terminal A1′ of transistor Cesd1′. Symmetrically, the channel region arranged under gate 804 is bordered on either side by two doped regions 810 and 812 of the second conductivity type, and respectively corresponding to the terminals A4′ and A3′ of device Dev2′. Region 810 also borders the channel region arranged under gate 802 and thus also corresponds to the conduction terminal A2′ of transistor Cesd1′.

In FIG. 8, the terminals A3′ and A4′ of devices Dev1′ and Dev2′ are shown as solid squares, and the terminals A1′, A2′, and C′ of transistor Cesd1′ are shown as solid squares, the gate contacts of transistors 700 are shown as solid squares, and the connections between these terminals and contacts are shown as dotted lines.

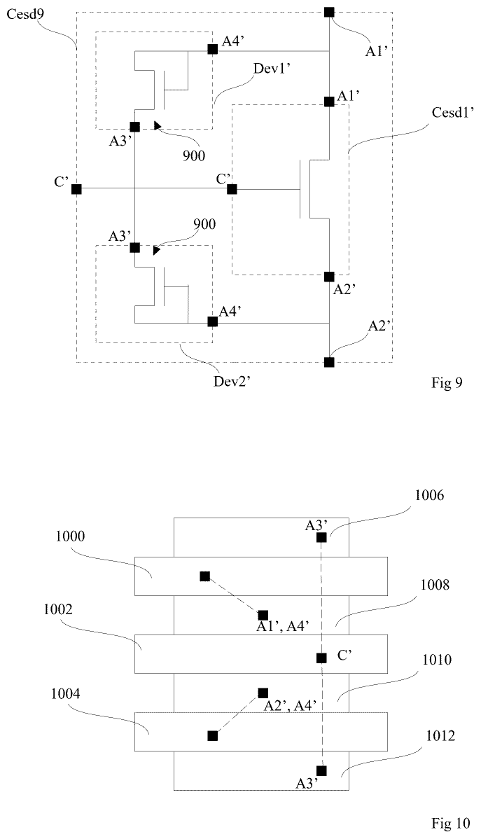

FIG. 9 shows still another example of a circuit Cesd9 equivalent to a BiMOS transistor, circuit Cesd9 being an ESD protection circuit.

Circuit Cesd9 has many elements in common with circuit Cesd5, and only the differences between these two circuits are detailed herein. Thus, unless otherwise indicated, all that has been indicated for circuit Cesd5, in particular its advantages and uses, applies to circuit Cesd9.

More particularly, circuit Cesd9 differs from circuit Cesd5 only by the implementation of its devices Dev1′ and Dev2′.

In each device Dev1′, Dev2′ of circuit Cesd9, diode 500 is replaced by a MOS transistor 900, for example with an N channel, with a gate connection to a conduction terminal. For example, in each of devices Dev1′ and Dev2′, a first conduction terminal of transistor 900 is connected to the terminal A3′ of the device, a second conduction terminal of the transistor 900 is connected to the terminal A4′ of the device, and the gate of transistor 900 is connected to its second conduction terminal.

FIG. 10 shows, in a simplified top view, an example of compact implementation of the circuit Cesd9 of FIG. 9.

Circuit Cesd9 comprises three gates 1000, 1002, and 1004 corresponding to the respective gates of the transistor 1000 of device Dev1′, of transistor Cesd1′, and of the transistor 1000 of device Dev2′, gate 1002 being arranged between gates 1000 and 1004. Each of gates 1000, 1002, and 1004 is arranged on a corresponding doped channel region of a first conductivity type, for example P. The channel region arranged under gate 1000 is bordered on either side by two respective doped regions 1006 and 1008 of a second conductivity type, for example N, and respectively corresponding to the terminals A3′ and A4′ of device Dev1′. Region 1008 also borders the channel region arranged under gate 1002 and thus also corresponds to the conduction terminal A1′ of transistor Cesd1′. Symmetrically, the channel region arranged under gate 1004 is bordered on either side by two respective doped regions, 1010 and 1012, of the second conductivity type, and respectively corresponding to the terminals A4′ and A3′ of device Dev2′. Region 1010 also borders the channel region arranged under gate 1002 and thus also corresponds to the conduction terminal A2′ of transistor Cesd1′.

In FIG. 10, the terminals A3′ and A4′ of devices Dev1′ and Dev2′ have been shown as solid squares, and the terminals A1′, A2′, and C′ of transistor Cesd1′ have been shown as solid squares, the gate contacts of transistors 900 have been shown as solid squares, and the connections between these terminals and contacts have been shown as dotted lines.

FIG. 11 shows still another example of a circuit Cesd11 equivalent to a BiMOS transistor, circuit Cesd11 being an ESD protection circuit.

Circuit Cesd11 has many elements in common with circuit Cesd5, and only the differences between these two circuits are here detailed. Thus, unless otherwise indicated, all that has been indicated for circuit Cesd5, in particular its advantages and uses, applies to circuit Cesd11.

More particularly, circuit Cesd11 differs from circuit Cesd5 only by the implementation of its devices Dev1′ and Dev2′.

In each device Dev1′, Dev2′ of circuit Cesd11, diode 500 is replaced by two MOS transistors 1100 and 1102, for example with an N channel. For example, in each of devices Dev1′ and Dev2′, a first conduction terminal of transistor 1100 is connected to the terminal A3′ of the device, a second conduction terminal of transistor 1100 is connected to the terminal A4′ of the device, the gate of transistor 1100 is connected to a first conduction terminal of transistor 1102, a second conduction terminal of transistor 1102 is connected to the terminal A4′ of the device, and the gate of transistor 1102 is also connected to the terminal A4′ of the device.

As compared with the devices Dev1′ and Dev2′ of circuits Cesd5, Cesd7, and Cesd9, the devices Dev1′ and Dev2′ of circuit Cesd11 enable circuit Cesd11 to be disabled when the electronic circuit comprising circuit Cesd11 is powered. To achieve this, a disable signal Ko is applied to the gate of the transistor 1100 of device 1100. This signal Ko is floating when the circuit comprising circuit Cesd11 is not powered, with the result that circuit Cesd11 behaves like a BiMOS transistor. Conversely, this signal Ko is at a voltage level enabling to turn on the transistor 1100 of device Dev2′ when the circuit comprising circuit Cesd11 is powered. As a result, the gate C′ of transistor Cesd1′ is pulled to terminal A2′ and transistor Cesd1 is held in the off state, circuit Cesd11 then being disabled. Thus, in the embodiment of FIG. 11, the control terminal C′ of the component Cesd1′ is coupled to the signal Ko. More particularly, the control terminal C′ of the component Cesd1′ is coupled to the signal Ko via the transistors 1100 and 1102 of the device Dev2′.

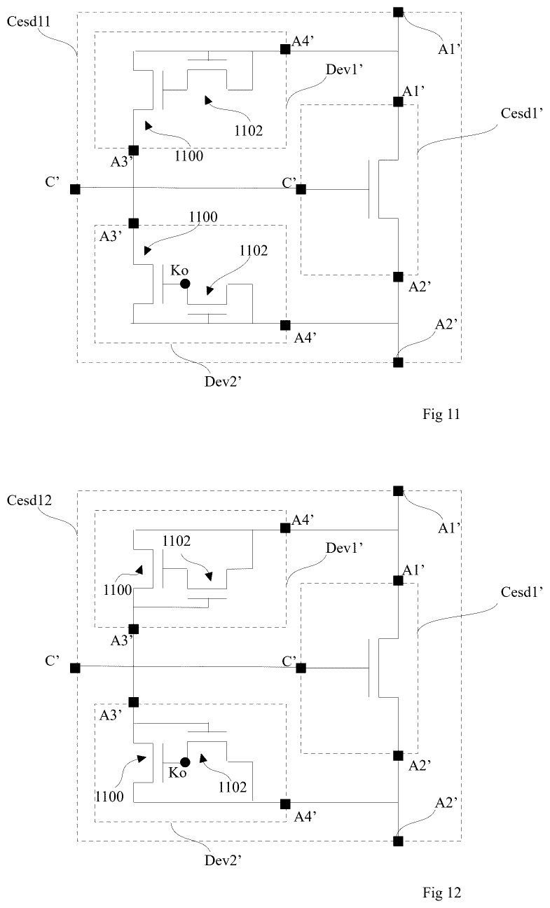

FIG. 12 shows still another example of an embodiment of a circuit Cesd12 equivalent to a BiMOS transistor, circuit Cesd12 being an ESD protection circuit.

Circuit Cesd12 comprises many elements in common with circuit Cesd11, and only the differences between these two circuits are detailed herein. Thus, unless otherwise indicated, all that has been indicated for circuit Cesd11, in particular its advantages and uses, applies to circuit Cesd12.

More particularly, circuit Cesd12 differs from circuit Cesd11 only by the implementation of its devices Dev1′ and Dev2′.

In each of the devices Dev1′ and Dev2′ of circuit Cesd12, the gate of transistor 1102 is connected to the terminal A3′ of the device, instead of terminal A4′ as was the case in FIG. 11.

As in FIG. 11, the devices Dev1′ and Dev2′ of circuit Cesd12 disable circuit Cesd12 by supplying signal Ko to the gate of the transistor 1100 of device Dev2′. Thus, in the embodiment of FIG. 12, the control terminal C′ of the component Cesd1′ is coupled to the signal Ko. More particularly, the control terminal C′ of the component Cesd1′ is coupled to the signal Ko via the transistors 1100 and 1102 of the device Dev2′.

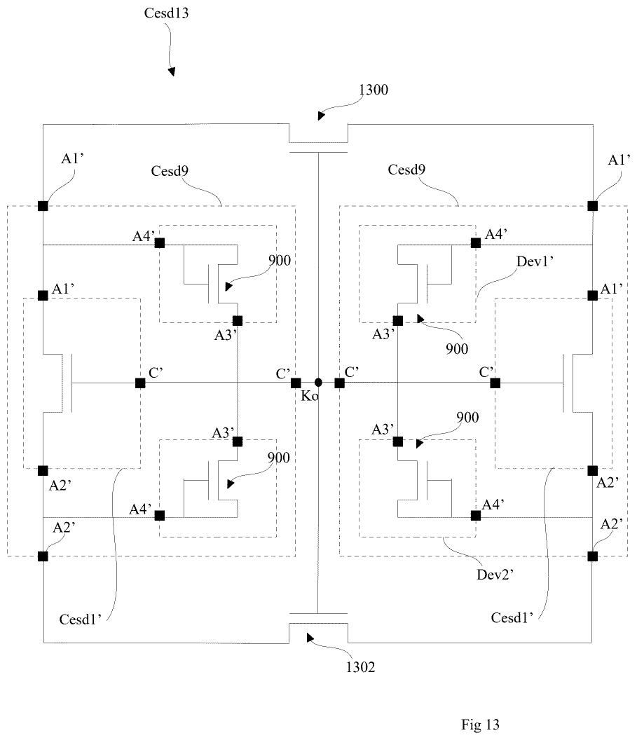

FIG. 13 shows another embodiment of an ESD protection circuit Cesd13.

Circuit, or device, Cesd13 comprises two circuits Cesd9 having their control terminals C′ connected to each other.

Circuit Cesd13 further comprises two MOS transistors 1300 and 1302, for example with an N channel. Transistors 1300 and 1302 are preferably identical to the MOS transistors Cesd1′ of circuits Cesd9.

Transistor 1300 has a first conduction terminal connected to the terminal A1′ of one of the two circuits Cesd9, a second conduction terminal connected to the terminal A1′ of the other of the two circuits Cesd9, and its gate connected to the control terminals C′ of circuits Cesd9.

Symmetrically, transistor 1302 has a first conduction terminal connected to the terminal A2′ of one of the two circuits Cesd9, a second conduction terminal connected to the terminal A2′ of the other of the two circuits Cesd9, and its gate connected to the control terminals C′ of circuits Cesd9.

Device Cesd13 enables to discharge an ESD occurring on any of the terminals A1′ and A2′ of any of circuits Cesd9. Indeed, device Cesd13 behaves like a BiMOS transistor between the terminals A1′ and A2′ of a first of the two circuits Cesd9, like a BiMOS transistor between the terminals A1′ and A2′ of a second of the two circuits Cesd9, but also like a BiMOS transistor between the terminals A1′ of the two circuits Cesd9, and like a BiMOS transistor between the terminals A1′ of the two circuits Cesd9.

Further, according to an embodiment, circuit Cesd13 is configured to receive the disable signal on the gate C′ of the transistor Cesd1′ of each of circuits Cesd9, and thus also on the gates of transistors 1300 and 1302. When device Cesd13 receives this signal Ko, it can then be disabled. Thus, in the embodiment of FIG. 13, the control terminal C′ of each component Cesd1′ is coupled to the signal Ko. More particularly, the control terminal C′ of each component Cesd1′ is connected to the signal.

Embodiments and variants of ESD protection circuit have been described. In the described examples, all the transistors, be they MOS or BiMOS, have an N channel. Indeed, for an equivalent surface area, an N-channel MOS or BiMOS transistor has better current properties. However, those skilled in the art will be capable of adapting the present disclosure to the case where all N-channel MOS transistors and all N-channel BiMOS transistors are respectively replaced by P-channel MOS transistors and by P-channel BiMOS transistors.

Various embodiments and variants have been described. Those skilled in the art will understand that certain features of these various embodiments and variants may be combined, and other variants will occur to those skilled in the art. In particular, the implementations of the circuits Cesd5, Cesd7, and Cesd9 described in relation with the respective FIGS. 6, 8, and 10, although they have the advantage of being compact, are not the only possible implementations, and those skilled in the art will be capable of providing others based on the present disclosure.

Finally, the practical implementation of the described embodiments and variants is within the abilities of those skilled in the art based on the functional indications given hereabove.

1. An electrostatic discharge protection circuit, comprising:
an electrostatic discharge dissipation component comprising a first conduction terminal, a second conduction terminal, and a control terminal for controlling a conduction state of the electrostatic discharge dissipation component between its first and second conduction terminals;
wherein the electrostatic discharge dissipation component is one of: a MOS transistor, a BiMOS transistor, and a circuit functionally equivalent to a BiMOS transistor; and
identical first and second devices each comprising first and second conduction terminals, the respective first conduction terminals of the first and second devices being connected to the control terminal of the electrostatic discharge dissipation component, the second conduction terminal of the first device being connected to the first conduction terminal of the electrostatic discharge dissipation component, and the second conduction terminal of the second device being connected to the second conduction terminal of the electrostatic discharge dissipation component.

2. The circuit according to claim 1, wherein each of the first and second devices comprises at least one PN junction.

3. The circuit according to claim 1, wherein each of the first and second devices is implemented by one of: a MOS transistor, a BiMOS transistor, and a circuit functionally equivalent to a BiMOS transistor.

4. The circuit according to claim 1, wherein:
each of the first and second devices further comprises a control terminal for controlling a conduction state of the device between its first and second conduction terminals;
each of the first and second devices is implemented by one of: a MOS transistor, a BiMOS transistor, and a circuit functionally equivalent to a BiMOS transistor;
further comprising:
a first MOS transistor having a first conduction terminal connected to the first conduction terminal of the electrostatic discharge dissipation component, a second conduction terminal connected to the control terminal of the second device, and a gate configured to receive a signal for disabling the electrostatic discharge protection circuit; and
a second MOS transistor having a first conduction terminal connected to the control terminal of the first device, a second conduction terminal connected to the second conduction terminal of the electrostatic discharge dissipation component, and a gate configured to receive the signal for disabling the electrostatic discharge protection circuit.

5. The circuit according to claim 1, further comprising:
a third device comprising a first conduction terminal connected to the first conduction terminal of the electrostatic discharge dissipation component, a second conduction terminal connected to the control terminal of the electrostatic discharge dissipation component, and a control terminal; and
a fourth device identical to the third device comprising a first conduction terminal connected to the second conduction terminal of the electrostatic discharge dissipation component, and a second conduction terminal connected to the second conduction terminal of the third device;
wherein each of the third and fourth devices is implemented by one of: a MOS transistor, a BiMOS transistor, and a circuit functionally equivalent to a BiMOS transistor; and
a first MOS transistor having a first conduction terminal connected to the first conduction terminal of the electrostatic discharge dissipation component, a second conduction terminal connected to the control terminal of the fourth device, and a gate configured to receive a signal for disabling the electrostatic discharge protection circuit; and
a second MOS transistor having a second conduction terminal connected to the second conduction terminal of the electrostatic discharge dissipation component, a first conduction terminal connected to the control terminal of the third device, and a gate configured to receive the signal for disabling the electrostatic discharge protection circuit.

6. The circuit according to claim 1, wherein the electrostatic discharge dissipation component is a MOS transistor, and the first and second devices do not comprise BiMOS transistors and are configured so that the electrostatic discharge protection circuit is functionally equivalent to a BiMOS transistor; and
wherein the first and second terminals of the electrostatic discharge dissipation component are functionally equivalent respectively to first and second conduction terminals of said BiMOS transistor, and the control terminal of the electrostatic discharge dissipation component is functionally equivalent to a gate of said BiMOS transistor.

7. The circuit according to claim 6, wherein each of the first and second devices comprises a gated diode having a first electrode connected to the first conduction terminal of said device, a second electrode connected to the second conduction terminal of said device, and a gate connected to its second conduction electrode.

8. The circuit according to claim 6, wherein each of the first and second devices comprises a MOS transistor having a conduction terminal connected to the first conduction terminal of said device, another conduction terminal connected to the second conduction terminal of said device, and a gate connected to the first conduction terminal of said device.

9. The circuit according to claim 6, wherein each of the first and second devices comprises:
a first MOS transistor having a gate, a first conduction terminal connected to the first conduction terminal of said device, a second conduction terminal connected to the second conduction terminal of said device; and
a second MOS transistor having a first conduction terminal connected to the second conduction terminal of said device, a second conduction terminal connected to the gate of the first MOS transistor, and a gate connected to the second conduction terminal of said device.

10. The circuit according to claim 9, wherein the gate of the first transistor of the second device is configured to receive a signal for disabling the circuit.

11. The circuit according to claim 6, wherein each of the first and second devices comprises:
a first MOS transistor having a gate, a first conduction terminal connected to the first conduction terminal of said device, a second conduction terminal connected to the second conduction terminal of said device; and
a second MOS transistor having a first conduction terminal connected to the second conduction terminal of said device, a second conduction terminal connected to the gate of the first MOS transistor, and a gate connected to the first conduction terminal of said device.

12. The circuit according to claim 11, wherein the gate of the first transistor of the second device is configured to receive a signal for disabling the circuit.

13. The circuit according to claim 6, wherein each of the first and second devices comprises a MOS transistor having a conduction terminal connected to the first conduction terminal of said device, another conduction terminal connected to the second conduction terminal of said device, and a gate connected to the second conduction terminal of said device.

14. An electrostatic discharge protection device, comprising:
a first circuit comprising the electrostatic discharge protection circuit according to claim 13; and
a second circuit comprising the electrostatic discharge protection circuit according to claim 13;
wherein the control terminal of the electrostatic discharge dissipation component of the first circuit is connected to the control terminal of the electrostatic discharge dissipation component of the second circuit;
a first MOS transistor having a gate connected to the control terminals of the electrostatic discharge dissipation components of the first and second circuits, a first conduction terminal connected to the first conduction terminal of the electrostatic discharge dissipation component of the first circuit, and a second conduction terminal connected to the first conduction terminal of the electrostatic discharge dissipation component of the second circuit; and
a second MOS transistor having a gate connected to the control terminals of the electrostatic discharge dissipation components of the first and second circuits, a first conduction terminal connected to the second conduction terminal of the electrostatic discharge dissipation component of the first circuit, and a second conduction terminal connected to the second conduction terminal of the electrostatic discharge dissipation component of the second circuit.

15. The device according to claim 14, wherein the gate of the first MOS transistor is configured to receive a signal for disabling the device.

16. An electrostatic discharge protection circuit, comprising:
an electrostatic discharge dissipation component comprising a first conduction terminal, a second conduction terminal, and a control terminal for controlling a conduction state of the electrostatic discharge dissipation component between its first and second conduction terminals;
wherein the electrostatic discharge dissipation component is a MOS transistor; and
identical first and second devices each comprising first and second conduction terminals, the respective first conduction terminals of the first and second devices being connected to the control terminal of the electrostatic discharge dissipation component, the second conduction terminal of the first device being connected to the first conduction terminal of the electrostatic discharge dissipation component, and the second conduction terminal of the second device being connected to the second conduction terminal of the electrostatic discharge dissipation component;
wherein each of the first and second devices comprises no BiMOS transistors and are functionally equivalent to a BiMOS transistor;
wherein the first and second terminals of the electrostatic discharge dissipation component are functionally equivalent respectively to first and second conduction terminals of said BiMOS transistor, and the control terminal of the electrostatic discharge dissipation component is functionally equivalent to a gate of said BiMOS transistor; and
wherein each of the first and second devices comprises:
a gated diode having a first electrode connected to the first conduction terminal of said device, a second electrode connected to the second conduction terminal of said device, and a gate connected to its second conduction electrode.

17. The circuit according to claim 16, wherein each of the first and second devices comprises at least one PN junction.

18. An electrostatic discharge protection circuit, comprising:
an electrostatic discharge dissipation component comprising a first conduction terminal, a second conduction terminal, and a control terminal for controlling a conduction state of the electrostatic discharge dissipation component between its first and second conduction terminals;
wherein the electrostatic discharge dissipation component is a MOS transistor; and
identical first and second devices each comprising first and second conduction terminals, the respective first conduction terminals of the first and second devices being connected to the control terminal of the electrostatic discharge dissipation component, the second conduction terminal of the first device being connected to the first conduction terminal of the electrostatic discharge dissipation component, and the second conduction terminal of the second device being connected to the second conduction terminal of the electrostatic discharge dissipation component;
wherein each of the first and second devices comprises no BiMOS transistors and are functionally equivalent to a BiMOS transistor;
wherein the first and second terminals of the electrostatic discharge dissipation component are functionally equivalent respectively to first and second conduction terminals of said BiMOS transistor, and the control terminal of the electrostatic discharge dissipation component is functionally equivalent to a gate of said BiMOS transistor; and
wherein each of the first and second devices comprises:
a MOS transistor having a conduction terminal connected to the first conduction terminal of said device, another conduction terminal connected to the second conduction terminal of said device, and a gate connected to one of the first conduction terminal or second confuction terminal of said device.

19. The circuit according to claim 18, wherein each of the first and second devices comprises at least one PN junction.

20. An electrostatic discharge protection circuit, comprising:
an electrostatic discharge dissipation component comprising a first conduction terminal, a second conduction terminal, and a control terminal for controlling a conduction state of the electrostatic discharge dissipation component between its first and second conduction terminals;
wherein the electrostatic discharge dissipation component is a MOS transistor; and
identical first and second devices each comprising first and second conduction terminals, the respective first conduction terminals of the first and second devices being connected to the control terminal of the electrostatic discharge dissipation component, the second conduction terminal of the first device being connected to the first conduction terminal of the electrostatic discharge dissipation component, and the second conduction terminal of the second device being connected to the second conduction terminal of the electrostatic discharge dissipation component;
wherein each of the first and second devices comprises no BiMOS transistors and are functionally equivalent to a BiMOS transistor;
wherein the first and second terminals of the electrostatic discharge dissipation component are functionally equivalent respectively to first and second conduction terminals of said BiMOS transistor, and the control terminal of the electrostatic discharge dissipation component is functionally equivalent to a gate of said BiMOS transistor; and
wherein each of the first and second devices comprises:
a first MOS transistor having a gate, a first conduction terminal connected to the first conduction terminal of said device, a second conduction terminal connected to the second conduction terminal of said device; and
a second MOS transistor having a first conduction terminal connected to the second conduction terminal of said device, a second conduction terminal connected to the gate of the first MOS transistor, and a gate connected to the second conduction terminal of said device.

21. The circuit of claim 20, wherein the gate of the first transistor of the second device is configured to receive a signal for disabling the circuit.

22. The circuit according to claim 20, wherein each of the first and second devices comprises at least one PN junction.
